(19) United States
(12) Patent Application Publication
(10) Pub. No.: US 2002/0023202 A1
(43) Pub. Date: Feb. 21, 2002

(54) Load value queue input replication in a simultaneous and redundantly threaded processor

(76) Inventor: Shubhendu S. Mukherjee, Framingham, MA (US)

Correspondence Address: CONLEY ROSE & TAYON, P.C., P. O. BOX 3267, HOUSTON, TX, 77253-3267, US

(21) Appl. No.: 09/839,624

(22) Filed: Apr. 19, 2001

Related U.S. Application Data
(60) Provisional application No. 60/198,530, filed on Apr. 19, 2000.

(51) Int. Cl. G06F 9/00

(52) U.S. Cl. 712/225

(57) ABSTRACT

A pipelined, simultaneous and redundantly threaded (“SRT”) processor configured to detect transient faults during program execution by executing instructions in at least two redundant copies of a program thread. The processor comprises load/store units configured to perform fetch and store operations to or from data sources and a load value queue for storing the data values fetched in response to data fetch instructions in a first program thread. The load/store units place a duplicate copy of the data in the load value queue after fetching the data from the data source and retiring the load instruction in the first thread. The load/store units access the load value queue and not the data source to fetch data values in response to corresponding data fetch instructions in the second program thread.

### CROSS-REFERENCE TO RELATED APPLICATIONS

This application is a non-provisional application claiming priority to provisional application Serial No. 60/198,530, filed on Apr. 19, 2000, entitled “Transient Fault Detection Via Simultaneous Multithreading,” the teachings of which are incorporated by reference herein.

This application is further related to the following co-pending applications, each of which is hereby incorporated herein by reference:

U.S. patent application Ser. No.______, filed______, and entitled “Slack Fetch to Improve Performance of a Simultaneous and Redundantly Threaded Processor,” Attorney Docket No. 1662-23801;

U.S. patent application Ser. No.______, filed_______, and entitled “Simultaneous and Redundantly Threaded Processor Store Instruction Comparator,” Attorney Docket No. 1662-36900;

U.S. patent application Ser. No.______, filed_______, and entitled “Cycle Count Replication in a Simultaneous and Redundantly Threaded Processor,” Attorney Docket No. 1662-37000;

U.S. patent application Ser. No._______, filed______, and entitled “Active Load Address Buffer,” Attorney Docket No. 1662-37100;

U.S. patent application Ser. No._______, filed_______, and entitled “Simultaneous and Redundantly Threaded Processor Branch Outcome Queue,” Attorney Docket No. 1662-37200;

U.S. patent application Ser. No._______, filed_______, and entitled “Input Replicator for Interrupts in a Simultaneous and Redundantly Threaded Processor,” Attorney Docket No. 1662-37300;

U.S. patent application Ser. No._______, filed_______, and entitled “Simultaneous and Redundantly Threaded Processor Uncached Load Address Comparator and Data Value Replication Circuit,” Attorney Docket No. 1662-37400.

### BACKGROUND OF THE INVENTION

1. Field of the Invention

The present invention generally relates to microprocessors. More particularly, the present invention relates to a pipelined, multithreaded processor that can execute a program in at least two separate, redundant threads. More particularly still, the invention relates to a method and apparatus for ensuring valid replication of loads from a data cache.

2. Background of the Invention

Solid state electronics, such as microprocessors, are susceptible to transient hardware faults. For example, cosmic rays or alpha particles can alter the voltage levels that represent data values in microprocessors, which typically include millions of transistors. Cosmic radiation can change the state of individual transistors causing faulty operation. The frequency of such transient faults is relatively low-typically less than one fault per year per thousand computers. Because of this relatively low failure rate, making computers fault tolerant currently is attractive more for mission-critical applications, such as online transaction processing and the space program, than computers used by average consumers. However, future microprocessors will be more prone to fault due to their smaller anticipated size, reduced voltage levels, higher transistor count, and reduced noise margins. Accordingly, even low-end personal computers may benefit from being able to protect against such faults.

One way to protect solid state electronics from faults resulting from cosmic radiation is to surround the potentially effected electronics by a sufficient amount of concrete. It has been calculated that the energy flux of the cosmic rays can be reduced to acceptable levels with six feet or more of concrete surrounding the computer containing the chips to be protected. For obvious reasons, protecting electronics from faults caused by cosmic ray with six feet of concrete usually is not feasible. Further, computers usually are placed in buildings that have already been constructed without this amount of concrete.

Rather than attempting to create an impenetrable barrier through which cosmic rays cannot pierce, it is generally more economically feasible and otherwise more desirable to provide the affected electronics with a way to detect and recover from a fault caused by cosmic radiation. In this manner, a cosmic ray may still impact the device and cause a fault, but the device or system in which the device resides can detect and recover from the fault. This disclosure focuses on enabling microprocessors (referred to throughout this disclosure simply as “processors”) to recover from a fault condition. One technique, such as that implemented in the Compaq Himalaya system, includes two identical “lockstepped” microprocessors. Lockstepped processors have their clock cycles synchronized and both processors are provided with identical inputs (i.e., the same instructions to execute, the same data, etc.). A checker circuit compares the processors' data output (which may also include memory addressed for store instructions). The output data from the two processors should be identical because the processors are processing the same data using the same instructions, unless of course a fault exists. If an output data mismatch occurs, the checker circuit flags an error and initiates a software or hardware recovery sequence. Thus, if one processor has been affected by a transient fault, its output likely will differ from that of the other synchronized processor. Although lockstepped processors are generally satisfactory for creating a fault tolerant environment, implementing fault tolerance with two processors takes up valuable real estate.

A “pipelined” processor includes a series of functional units (e.g., fetch unit, decode unit, execution units, etc.), arranged so that several units can be simultaneously processing an appropriate part of several instructions. Thus, while one instruction is being decoded, an earlier fetched instruction can be executed. A “simultaneous multithreaded” (“SMT”) processor permits instructions from two or more different program threads (e.g., applications) to be processed through the processor simultaneously. An “out-of-order” processor permits instructions to be processed in an order that is different than the order in which the instructions are provided in the program (referred to as “program order”). Out-of-order processing potentially increases the throughput efficiency of the processor. Accordingly, an SMT processor can process two programs simultaneously.

An SMT processor can be modified so that the same program is simultaneously executed in two separate threads to provide fault tolerance within a single processor. Such a processor is called a simultaneous and redundantly threaded (“SRT”) processor. Some of the modifications to turn a SMT processor into an SRT processor are described in Provisional Application Serial No. 60/198,530.

Executing the same program in two different threads permits the processor to detect faults such as may be caused by cosmic radiation, noted above. By comparing the output data from the two threads at appropriate times and locations within the SRT processor, it is possible to detect whether a fault has occurred. For example, data written to cache memory or registers that should be identical from corresponding instructions in the two threads can be compared. If the output data matches, there is no fault. Alternatively, if there is a mismatch in the output data, a fault has presumably occurred in one or both of the threads.

Executing the same program in two separate threads advantageously affords the SRT processor some degree of fault tolerance, but also may cause several performance problems. For instance, any latency caused by a cache miss is exacerbated. Cache misses occur when an instruction requests data from memory that is not also available in cache memory. The processor first checks whether the requested data already resides in the faster access cache memory, which generally is onboard the processor die. If the requested data is not present in cache (a condition referred to as a cache “miss”), then the processor is forced to retrieve the data from main system memory which takes more time, thereby causing latency, than if the data could have been retrieved from the faster onboard cache. Because the two threads are executing the same instructions, any instruction in one thread that results in a cache miss will also experience the same cache miss when that same instruction is executed in other thread. That is, the cache latency will be present in both threads.

A second performance problem concerns branch misspeculation. A branch instruction requires program execution either to continue with the instruction immediately following the branch instruction if a certain condition is met, or branch to a different instruction if the particular condition is not met. Accordingly, the outcome of a branch instruction is not known until the instruction is executed. In a pipelined architecture, a branch instruction (or any instruction for that matter) may not be executed for at least several, and perhaps many, clock cycles after the branch instruction is fetched by the fetch unit in the processor. In order to keep the pipeline full (which is desirable for efficient operation), a pipelined processor includes branch prediction logic which predicts the outcome of a branch instruction before it is actually executed (also referred to as “speculating”). Branch prediction logic generally bases its speculation on short or long term history. As such, using branch prediction logic, a processor's fetch unit can speculate the outcome of a branch instruction before it is actually executed. The speculation, however, may or may not turn out to be accurate. That is, the branch predictor logic may guess wrong regarding the direction of program execution following a branch instruction. If the speculation proves to have been accurate, which is determined when the branch instruction is executed by the processor, then the next instructions to be executed have already been fetched and are working their way through the pipeline.

If, however, the branch speculation turns out to have been the wrong prediction (referred to as “misspeculation”), many or all of the instructions filling the pipeline behind the branch instruction may have to be thrown out (i.e., not executed) because they are not the correct instructions to be executed after the branch instruction. The result is a substantial performance hit as the fetch unit must fetch the correct instructions to be processed through the pipeline. Suitable branch prediction methods, however, result in correct speculations more often than misspeculations and the overall performance of the processor is improved with a suitable branch predictor (even in the face of some misspeculations) than if no speculation was available at all.

In an SRT processor that executes the same program in two different threads for fault tolerance, any branch misspeculation is exacerbated because both threads will experience the same misspeculation. Because the branch misspeculation occurs in both threads, the processor's internal resources usable to each thread are wasted while the wrong instructions are replaced with the correct instructions.

In an SRT processor, threads may be separated by a predetermined amount of slack to improve performance. In this scenario, one thread is processed ahead of the other thread thereby creating a “slack” of instructions between the two threads so that the instructions in one thread are processed through the processor's pipeline ahead of the corresponding instructions from the other thread. The thread whose instructions are processed earlier is called the “leading” thread, while the other thread is the “trailing” thread. By setting the amount of slack (in terms of numbers of instructions) appropriately, all or at least some of the cache misses or branch misspeculations encountered by the leading thread can be resolved before the corresponding instructions from the trailing thread are fetched and processed through the pipeline.

In an SRT processor, the processor verifies that inputs to the multiple threads are identical to guarantee that both execution copies or threads follow precisely the same path. Thus, corresponding operations that input data from other locations within the system (e.g., memory, cycle counter), must return the same data values to both redundant threads. Otherwise, the threads may follow divergent execution paths, leading to different outputs that will be detected and handled as if a hardware fault occurred.

One potential problem in running two separate, but redundant threads in a computer processor arises in reading data from a data cache. Input replication of cached load data is problematic because data values can be modified between loads by the redundant threads. For example, data values in a data cache may be updated by other processors or by DMA I/O devices between load accesses. Thus, when the trailing thread loads data from the data cache, the value may be different from the value retrieved by the leading thread. The different inputs will likely lead to divergent execution paths and the outputs from each thread will therefore differ. As a result, a fault is reported and recovery techniques are implemented to re-execute the threads from a last “known good” state. By replicating the cached load data, erroneous transient fault conditions resulting from processing different data are advantageously avoided.

Other SRT processor solutions have not addressed the potential problem of data cache content changes and suggest merely that both threads probe the data cache when needed. The underlying theory in these prior art solutions is that any discrepancies in the data cache load values will be caught during output comparison. Reliance on this type of error detection is inefficient because the processor invariably has to re-execute each thread. In addition, it is possible that the conditions that produced the data cache changes during the first execution will recur, therefore resulting in an unwanted loop scenario. It is desirable therefore, to provide a means of replicating cache data loads to prevent divergent execution paths and increase SRT processor efficiency.

### BRIEF SUMMARY OF THE INVENTION

The problems noted above are solved in large part by a simultaneous and redundantly threaded processor that can simultaneously execute the same program in two separate threads to provide fault tolerance. By simultaneously executing the same program twice, the system can be made fault tolerant by checking the output data pertaining to corresponding instructions in the threads to ensure that the data matches. A data mismatch indicates a fault in the processor effecting one or both of the threads. The preferred embodiment of the invention provides an increase in performance to such a fault tolerant, simultaneous and redundantly threaded processor.

The preferred embodiment includes a pipelined, simultaneous and redundantly threaded (“SRT”) processor, comprising a program counter for each redundant thread configured to assign program count identifiers to instructions that are retrieved by the processor, floating point execution units configured to execute floating point instructions, integer execution units configured to execute integer-based instructions, load/store units configured to perform fetch and store operations to or from data sources such as a data cache, memory, and data registers and a register update unit configured to hold instructions in a queue until the instructions are executed and retired by the SRT processor. The SRT processor is configured to detect transient faults during program execution by executing instructions in at least two redundant copies of a program thread. False errors caused by incorrectly replicating fetched data in the redundant program threads are avoided by using the actual data from data fetch instructions in a first program thread for the second program thread.

The SRT processor also includes a load value queue for storing the data values fetched in response to data fetch instructions in the first program thread, also referred to as the leading thread. The load/store units place a duplicate copy of the data in the load value queue after fetching the data from the data source. The duplicate data is not placed in the load value queue until the data fetch instructions in the first thread retire from the register update unit. The load/store units then access the load value queue and not the data source to fetch data values when the corresponding data fetch instructions are encountered in the second, trailing program thread. The SRT processor is preferably an out-of-order processor capable of executing instructions in the most efficient order. However, data fetch instructions are executed in program order in the trailing thread.

The load value queue is preferably implemented using a FIFO buffer. Individual load value entries in the load value queue comprise the size of the data value loaded, an address indicating the physical location in the data source from which the data was fetched, and the data value that was retrieved by the load/store units when the fetch command was executed. If the load value queue becomes full, the first thread is stalled to prevent more data values from entering the load value queue. Conversely, if the load value queue becomes empty, the second thread is stalled to allow data values to enter the load value queue.

### BRIEF DESCRIPTION OF THE DRAWINGS

For a detailed description of the preferred embodiments of the invention, reference will now be made to the accompanying drawings in which:

FIG. 1 is a diagram of a computer system constructed in accordance with the preferred embodiment of the invention and including a simultaneous and redundantly threaded processor;

FIG. 2 is a graphical depiction of the input replication and output comparison executed by the simultaneous and redundantly threaded processor according to the preferred embodiment;

FIG. 3 conceptually illustrates the slack between the execution of two threads containing the same instruction set but with one thread trailing the other thread;

FIG. 4 is a block diagram of the simultaneous and redundantly threaded processor from FIG. 1 in accordance with the preferred embodiment that includes a load value queue for replication of cache data loads;

FIG. 5 is a diagram of a Register Update Unit in accordance with a preferred embodiment; and

FIG. 6 is a diagram of a Load Value Queue in accordance with a preferred embodiment.

### NOTATION AND NOMENCLATURE

Certain terms are used throughout the following description and claims to refer to particular system components. As one skilled in the art will appreciate, microprocessor companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

FIG. 1 shows a computer system 90 including a pipelined, simultaneous and redundantly threaded (“SRT”) processor 100 constructed in accordance with the preferred embodiment of the invention. In addition to processor 100, computer system 90 also includes dynamic random access memory (“DRAM”) 92, an input/output (“I/O”) controller 93, and various I/O devices which may include a floppy drive 94, a hard drive 95, a keyboard 96, and the like. The I/O controller 93 provides an interface between processor 100 and the various I/O devices 94-96. The DRAM 92 can be any suitable type of memory devices such as RAMBUS™ memory. In addition, SRT processor 100 may also be coupled to other SRT processors if desired in a commonly known “Manhattan” grid, or other suitable architecture.

The preferred embodiment of the invention ensures correct operation and provides a performance enhancement to SRT processors. The preferred SRT processor 100 described above is capable of processing instructions from two different threads simultaneously. Such a processor in fact can be made to execute the same program as two different threads. In other words, the two threads contain the same program set. Processing the same program through the processor in two different threads permits the processor to detect faults caused by cosmic radiation or alpha particles as noted above.

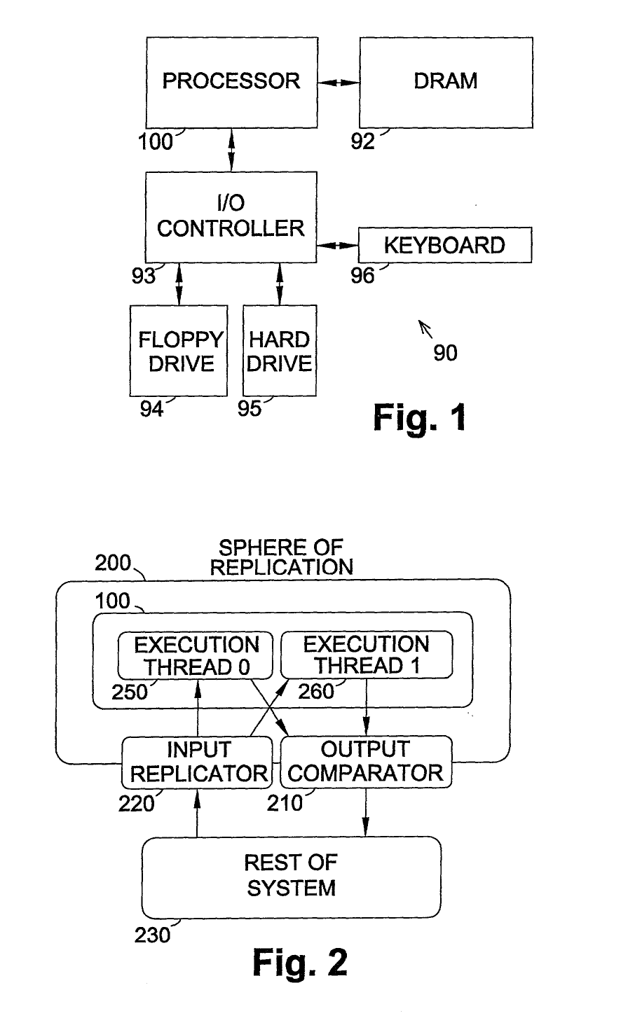

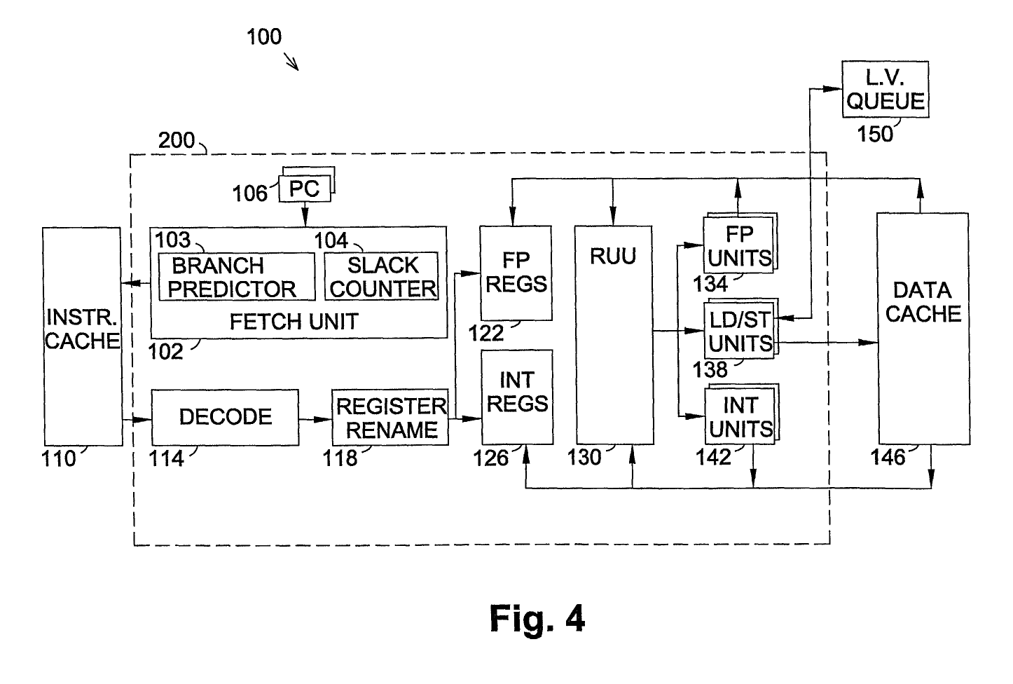

FIG. 2 conceptually shows the simultaneous and redundant execution of threads 250, 260 in the processor 100. The threads 250, 260 are referred to as Thread 0 (“T0”) and Thread 1 (“T1”). In accordance with the preferred embodiment, the processor 100 or a significant portion thereof resides in a sphere of replication 200, which defines the boundary within which all activity and states are replicated either logically or physically. Values that cross the boundary of the sphere of replication are the outputs and inputs that require comparison 210 and replication 220, respectively. Thus, a sphere of replication 200 that includes fewer components may require fewer replications but may also require more output comparisons because more information crosses the boundary of the sphere of replication. The preferred sphere of replication is described in conjunction with the discussion of FIG. 4 below.

All inputs to the sphere of replication 200 must be replicated 220. For instance, an input resulting from a memory load command must return the same value to each execution thread 250, 260. If two distinctly different values are returned, the threads 250, 260 may follow divergent execution paths. Similarly, the outputs of both threads 250, 260 must be compared 210 before the values contained therein are shared with the rest of the system 230. For example, each thread may need to write data to memory 92 or send a command to the I/O controller 93. If the outputs from the threads 250, 260 are identical, then it is assumed that no transient faults have occurred and a single output is forwarded to the appropriate destination and thread execution continues. Conversely, if the outputs do not match, then appropriate error recovery techniques may be implemented to re-execute and re-verify the “faulty” threads.

It should be noted that the rest of the system 230, which may include such components as memory 92, I/O devices 93-96, and the operating system need not be aware that two threads of each program are executed by the processor 100. In fact, the preferred embodiment generally assumes that all input and output values or commands are transmitted as if only a single thread exists. It is only within the sphere of replication 200 that the input or output data is replicated.

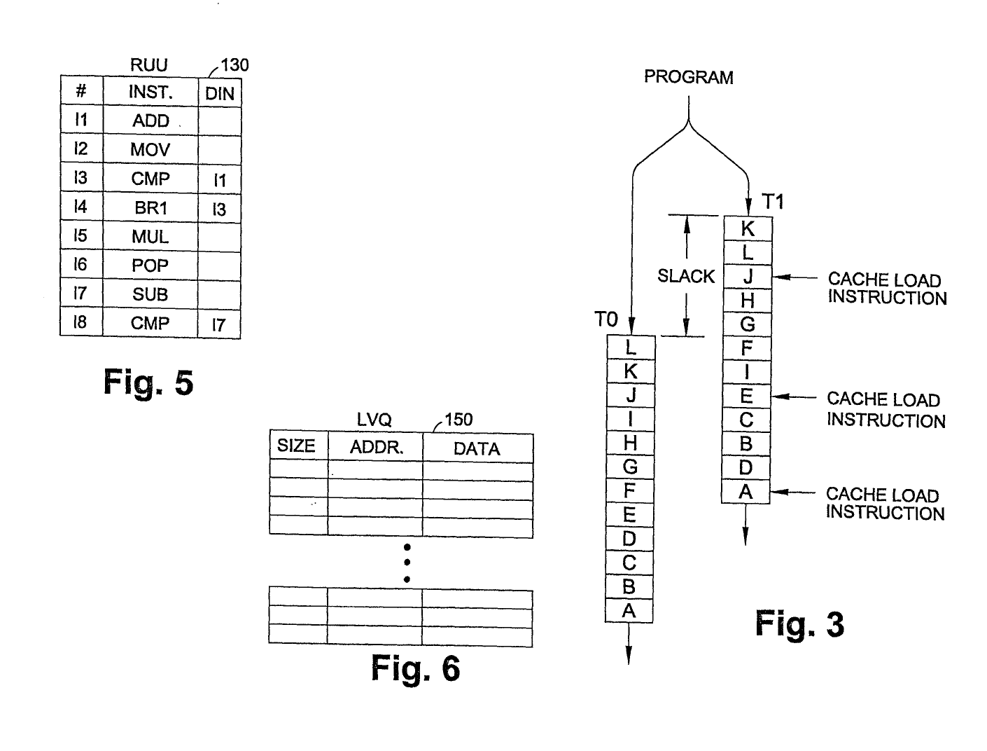

FIG. 3 shows two distinct, but replicated copies of a program thread T0 & T1 presumably executed in the same pipeline. Thread T0 is arbitrarily designated as the “leading” thread while thread T1 is designated as the “trailing” thread. The threads may be separated in time by a pre-determined slack and may also be executed out of program order. Slack is a generally desirable condition in an SRT processor 100 and may be implemented by a dedicated slack fetch unit or a branch outcome queue as described below.

The amount of slack in the example of FIG. 3 is five instructions. In general, the amount of slack can be any desired number of instructions. For example, as shown in Provisional patent application 60/198530 filed on Apr. 19, 2000, an optimal slack of 256 instructions was shown to provide a performance increase without introducing unnecessary overhead. The amount of slack can be preset or programmable by the user of computer system 90 and preferably is large enough to permit the leading thread to resolve some, most, or all cache misses and branch misspeculations before the corresponding instructions from the trailing thread are executed. It will also be understood by one of ordinary skill in the art that, in certain situations, the two threads will have to be synchronized thereby reducing the slack to zero. Examples of such situations include uncached loads and external interrupts.

As discussed above, the preferred embodiment of the SRT processor 100 is capable of executing instructions out of order to achieve maximum pipeline efficiency. Instructions in the leading thread are fetched and retired in program order, but may be executed in any order that keeps the pipeline full. In the preferred embodiment, however, cached loads in the trailing thread are fetched, executed, and retired by the processor in program order. For example, in the representative example shown in FIG. 3, the stack on the left represents instructions as they are retired by the leading thread T0. The instructions in the leading thread T0 may have been executed out-of-order, but they are retired in their original, program order. The stack on the right represents the execution order for instructions in the trailing thread T1. Instructions A, E, and J represent cache load instructions. The remaining instructions may or may not depend on instructions A, E, and J and may or may not be executed in program order. It is assumed however, in accordance with the preferred embodiment that non-load instructions may be executed out of order. Thus, instructions B-D, F-I and K-L are executed in different orders while load instructions A, E, and J are executed in their original order.

Referring to FIG. 4, processor 100 preferably comprises a pipelined architecture which includes a series of functional units, arranged so that several units can be simultaneously processing appropriate parts of several instructions. As shown, the exemplary embodiment of processor 100 includes a fetch unit 102, one or more program counters 106, an instruction cache 110, decode logic 114, register rename logic 118, floating point and integer registers 122, 126, a register update unit 130, execution units 134, 138, and 142, a data cache 146, and a load value queue 150.

Fetch unit 102 uses a program counter 106 associated with each thread for assistance as to which instruction to fetch. Being a multithreaded processor, the fetch unit 102 preferably can simultaneously fetch instructions from multiple threads. Each program counter 106 is a register that contains the address of the next instruction to be fetched from the corresponding thread by the fetch unit 102. FIG. 4 shows two program counters 106 to permit the simultaneous fetching of instructions from two threads. It should be recognized, however, that additional program counters can be provided to fetch instructions from more than two threads.

As shown, fetch unit 102 includes branch prediction logic 103 and a “slack” counter 104. Slack counter 104 is used to create a delay of a desired number of instructions between the threads that include the same instruction set. The introduction of slack permits the leading thread T0 to resolve all or most branch misspeculations and cache misses so that the corresponding instructions in the trailing thread T1 will not experience the same latency problems. The branch prediction logic 104 permits the fetch unit 102 to speculate ahead on branch instructions as noted above. In order to keep the pipeline full (which is desirable for efficient operation), the branch predictor logic 103 speculates the outcome of a branch instruction before the branch instruction is actually executed. Branch predictor 103 generally bases its speculation on previous instructions. Any suitable speculation algorithm can be used in branch predictor 103.

Referring still to FIG. 4, instruction cache 110 provides a temporary storage buffer for the instructions to be executed. Decode logic 114 retrieves the instructions from instruction cache 110 and determines the instruction type (e.g., add, subtract, load, store, etc.). Decoded instructions are then passed to the register rename logic 118 which maps logical registers onto a pool of physical registers.

The register update unit (“RUU”) 130 provides an instruction queue for the instructions to be executed. The RUU 130 serves as a combination of global reservation station pool, rename register file, and reorder buffer. The RUU 130 breaks load and store instructions into an address portion and a memory (i.e., register) reference. The address portion is placed in the RUU 130, while the memory reference portion is placed into a load/store queue (not specifically shown in FIG. 4).

The RUU 130 also handles out-of-order execution management. As instructions are placed in the RUU 130, any dependence between instructions (e.g., one instruction depends on the output from another or because branch instructions must be executed in program order) is maintained by placing appropriate dependent instruction numbers in a field associated with each entry in the RUU 130. FIG. 5 provides a simplified representation of the various fields that exist for each entry in the RUU 130. Each instruction in the RUU 130 includes an instruction number, the instruction to be performed, and a dependent instruction number (“DIN”) field. As instructions are executed by the execution units 134, 138, 142, dependency between instructions can be maintained by first checking the DIN field for instructions in the RUU 130. For example, FIG. 5 shows 8 instructions numbered I1 through I8 in the representative RUU 130. Instruction 13 includes the value I1 in the DIN field which implies that the execution of I3 depends on the outcome of I1. Thus, execution units 134, 138, 142 recognize that instruction number I1 must be executed before instruction I3. Therefore, in the example shown in FIG. 5, the same dependency exists between instructions I4 and I3 as well as I8 and I7. Meanwhile, independent instructions (i.e., those with no number in the dependent instruction number field) may be executed out of order.

Referring again to FIG. 4, the floating point register 122 and integer register 126 are used for the execution of instructions that require the use of such registers as is known by those of ordinary skill in the art. These registers 122, 126 can be loaded with data from the data cache 146. The registers also provide their contents to the RUU 130.

As shown, the execution units 134, 138, and 142 comprise a floating point execution unit 134, a load/store execution unit 138, and an integer execution unit 142. Each execution unit performs the operation specified by the corresponding instruction type. Accordingly, the floating point execution units 134 execute floating instructions such as multiply and divide instruction while the integer execution units 142 execute integer-based instructions. The load/store units 138 perform load operations in which data from memory or the data cache 146 is loaded into a register 122 or 126. The load/ store units 138 also perform store operations in which data from registers 122, 126 is written to data cache 146 and/or DRAM memory 92 (FIG. 1). The function of the load value queue 150 is discussed in further detail below.

The architecture and components described herein are typical of microprocessors, and particularly pipelined, multithreaded processors. Numerous modifications can be made from that shown in FIG. 4. For example, the locations of the RUU 130 and registers 122, 126 can be reversed if desired. For additional information, the following references, all of which are incorporated herein by reference, may be consulted for additional information if needed: U.S. patent application Ser. No. 08/775,553, filed Dec. 31, 1996, and “Exploiting Choice: Instruction Fetch and Issue on an Implementable Simultaneous Multithreaded Processor,” by D. Tullsen, S. Eggers, J. Emer, H. Levy, J. Lo and R. Stamm, Proceedings of the 23^{rd} Annual International Symposium on Computer Architecture, Philadelphia, Pa., May 1996.

According to the preferred embodiment, the sphere of replication is represented by the dashed box shown in FIG. 4. The majority of the pipelined processor components are included within the sphere of replication 200 with the notable exception of the instruction cache 110 and the data cache 146. The floating point and integer registers 122, 126 may alternatively reside outside of the sphere of replication 200, but for purposes of this discussion, they will remain as shown. Since the data cache 146 resides outside the sphere of replication 200, all loads from the data cache 146 must be replicated. It should also be noted that since the load value queue 150 resides outside the sphere of replication, all information that is transmitted between the sphere of replication 200 and the load value queue 150 must be protected with some type of error detection, such as parity or error checking and correcting (“ECC”). Parity is an error detection method that is well-known to those skilled in the art. ECC goes one step further and provides a means of correcting errors. ECC uses extra bits to store an encrypted code with the data. When the data is written to a source location, the ECC code is simultaneously stored. Upon being read back, the stored ECC code is compared to the ECC code generated when the data was read. If the codes don't match, they are decrypted to determine which bit in the data is incorrect. The erroneous bit may then be flipped to correct the data.

The preferred embodiment provides an effective means of replicating data cache values returned from cache load commands in the leading thread T0 and delivering a “copy” to the trailing thread T1. Upon encountering an cache load command in the leading thread T0, the load/store units 138 load the appropriate data value from the data cache 146 to the target register as a conventional processor would. After the load instruction in the leading thread T0 executes, the instruction is stored in the RUU 130 until the instruction commits (“committing” an instruction refers to the process of completing the execution of and retiring an instruction). After the cached load commits, the load/store units 138 send the load address and load value to the LVQ 150. The trailing thread performs loads in program order and non-speculatively and the loads in the trailing thread proceed through the regular processor pipeline. However, instead of probing the data cache 146, the trailing thread T1 waits until the corresponding load address and value from the leading thread T0 appear at the head of the LVQ 150. Input replication is guaranteed because the trailing thread receives the same value for the load that the leading thread used.

The LVQ 150 is preferably a FIFO buffer that stores the cache load values until the corresponding load commands are encountered in the trailing thread T1. The LVQ 150 preferably includes, at a minimum, the fields shown in FIG. 6. Entries in the representative LVQ 150 shown in FIG. 6 include the size of the loaded value, a load address, and the data value. The size entry holds the size of the loaded value and is typically 1, 2, 4, or 8 bytes in length. The address is the physical location in the data cache 146 from which the data was loaded. The data value is the value that was retrieved by the leading thread T0 when the load command was issued. When a cache load command is issued in the trailing thread T1, the load/store units 138 read the data value from the LVQ 150 (and not the data cache 146). Since the buffer delivers the oldest data values in the stack, and assuming the load commands are encountered in program order in the trailing thread, the same data values are returned to each thread. The data cache values are, therefore, properly replicated and correct operation is guaranteed. Further, erroneous faults are not generated. The assumed program order is maintained by creating appropriate dependencies in the RUU 130 (as discussed above) between the cache load commands and instructions immediately before or after the cache load command.

The preferred embodiment described herein provides the advantage of requiring only one probe of the data cache 146. This eliminates the problem where data cache values change between corresponding loads in threads TO and T1. Additionally, the LVQ 150 can accelerate fault detection of faulty addresses by comparing the effective address of the leading thread (from the LVQ 150) with the effective address of the trailing thread.

Accordingly, the preferred embodiment of the invention provides a method of replicating cache data values in an SRT processor that can execute the same instruction set in two different threads. The above discussion is meant to be illustrative of the principles and various embodiments of the present invention. Numerous variations and modifications will become apparent to those skilled in the art once the above disclosure is fully appreciated. For instance, the discussion provided to this point has been directed at loads from the processor data cache 146. It should be noted, however, that teachings herein may also be extended to include loads from system memory 92 or other inputs that must be replicated for delivery to threads in an SRT processor 100. It is intended that the following claims be interpreted to embrace all such variations and modifications.

What is claimed is:

1. A computer system, comprising:
a pipelined, simultaneous and redundantly threaded (“SRT”) processor comprising at least one data cache;
an I/O controller coupled to said processor, which in turn is coupled to at least one I/O device;
a main system memory coupled to said processor; and
wherein said SRT processor processes a set of instructions in a leading thread and also in a redundant trailing thread to detect transient faults in the computer system; and
wherein when a data load command appears in the leading thread, the processor loads the requested data and replicates the value for the corresponding data load command in the trailing thread.

2. The computer system of claim 1 further comprising a load value queue;
wherein when the processor loads the requested data, the processor stores the same data in the load value queue.

3. The computer system of claim 2 wherein the processor does not store the data value in the load value queue until the data load command in the leading thread commits.

4. The computer system of claim 2 wherein the load value queue is a FIFO buffer and wherein all data load commands in the trailing thread are executed by the processor in their original, program order.

5. The computer system of claim 2 wherein the data load command is a request for data in the data cache.

6. The computer system of claim 2 wherein the data load command is a request for data in the main system memory.

7. The computer system of claim 4 wherein if the load value queue becomes full, execution of instructions in the leading thread is temporarily halted to prevent more data values from entering the load value queue; and
wherein if the load value queue becomes empty, execution of instructions in the second thread is temporary halted to allow more data values to enter the load value queue.

8. A pipelined, simultaneous and redundantly threaded (“SRT”) processor, comprising:
a program counter configured to assign program count identifiers to instructions in each thread that are retrieved by the processor;
floating point execution units configured to execute floating point instructions;
integer execution units configured to execute integer-based instructions;
load/store units configured to perform fetch and store operations to or from data sources such as a data cache, memory, and data registers; and
Wherein said processor is configured to detect transient faults during program execution by executing instructions in at least two redundant copies of a program thread and wherein false errors caused by incorrectly replicating fetched data in the redundant program threads are avoided by replicating the actual data retrieved from data fetch instructions in a first program thread for a second program thread.

9. The SRT processor of claim 8 wherein the processor further comprises:
a load value queue for storing the data values fetched in response to data fetch instructions in the first program thread;
wherein the load/store units place a duplicate copy of the data in the load value queue after fetching the data from the data source and wherein the load/store units access the load value queue and not the data source to fetch data values in response to data fetch instructions in the second program thread.

10. The SRT processor of claim 9 further comprising a register update unit;
wherein the register update unit is configured to hold instructions in a queue until the instructions are executed and retired by the SRT processor and wherein the data fetched by the load/store units in response to data fetch instructions in the first program thread is not placed in the load value queue until the data fetch instructions in the first program thread retire from the register update unit.

11. The SRT processor of claim 9 wherein the SRT processor is an out-of-order processor capable of executing instructions in the most efficient order, but wherein data fetch instructions are executed in the same order in both the first and second program threads.

12. The SRT processor of claim 11 wherein the load value queue is a FIFO buffer and data is transmitted to and from the buffer using an error correction technique.

13. The SRT processor of claim 12 wherein the individual load value entries in the load value queue comprise:
the size of the fetched data value;
an address indicating the physical location in the data source from which the data was fetched; and
the data value that was retrieved by the load/store units when the fetch command was executed.

14. The SRT processor of claim 12 wherein if the load value queue becomes full, the first thread is stalled to prevent more data values from entering the load value queue; and
wherein if the load value queue becomes empty, the second thread is stalled to allow data values to enter the load value queue.

15. A method of replicating data values in an SRT processor which can fetch and execute a program set in two separate threads so that each thread includes substantially the same instructions as the other thread, one of said threads being a leading thread and the other of said threads being a trailing thread, the method comprising:
accessing a data source to load a data value when the leading thread requests said data;
storing the data value in a load value queue;
accessing the load value queue for the data value for corresponding data requests in the trailing thread.

16. The method of claim 15 further comprising:
executing the data requests in the trailing thread in program order.

17. The method of claim 16 further comprising:
storing the data values in the load value queue after the data requests in the leading thread execute.

18. The method of claim 17 further comprising:
storing the data value in a FIFO buffer; and
storing the following information with each entry in the buffer:
the size of the data value;
an address indicating the physical location in the data source from which the data was fetched; and
the data value that was retrieved by the data request in the leading thread.

19. The method of claim 18 wherein the data source is a data cache.

20. The method of claim 18 wherein the data source is system memory source.

21. The method of claim 17 further comprising:
transmitting data to and from the load value queue using an error correction technique.
